(19) United States
(12) Patent Application Publication
(10) Pub. No.: US 2009/0191504 A1
(43) Pub. Date: Jul. 30, 2009

(54) INTRA-ORAL LIGHTING DEVICE AND LIGHTING METHOD

(76) Inventor: Thomas C. Mannino, Farmington Hills, MI (US)

Correspondence Address: HOWARD & HOWARD ATTORNEYS PLLC, 450 West Fourth Street, Royal Oak, MI, 48067, US

(21) Appl. No.: 12/362,200

(22) Filed: Jan. 29, 2009

Related U.S. Application Data
(60) Provisional application No. 61/062,968, filed on Jan. 30, 2008.

(51) Int. Cl. A61C 3/00

(52) U.S. Cl. 433/29

(57) ABSTRACT

An intra-oral lighting device for illuminating a tooth located in the mouth of a patient, the device including a source of light, and a probe through which light from the source of light is transmitted, the probe including a tip from which light received from the source of light by the probe is emitted, the tip being insertable by a user into an aperture bored into the enamel of the patient's tooth whereby the tooth is illuminated from within by light emitted from the tip. Also, a method of illuminating a tooth disposed in the mouth of a patient, including the steps of drilling into the tooth a hole that extends into the tooth enamel, inserting into the drilled hole the tip of a light-transmitting probe connected to a source of light, and emitting light from the probe tip disposed in the drilled hole, whereby the tooth is illuminated from within by light transmitted into and through the tooth enamel from the probe tip.

### BACKGROUND OF THE INVENTION

1. Field of the Invention

The subject invention relates to a dental light for illuminating the teeth or interior of the mouth of a patient.

2. Description of the Prior Art

Proper lighting is critical to safe and effective completion of a dental procedure. Devices for illuminating the interior of the mouth of a patient for assisting a user (e.g., a dentist or oral surgeon) with dental procedures are well known in the art. An overhead lamp is often used to emit light for illuminating the mouth of the patient, but has several limitations. The overhead lamp does not adequately light the interior of the mouth and must constantly be repositioned to overcome shadows created by the user. Another method commonly used in the art includes a mirror for redirecting the light. Although more effective, this method requires the user to hold the mirror while performing the procedure.

Therefore, there remains a need to illuminate the interior of the mouth, and particularly a tooth or teeth of interest, without having to constantly reposition or redirect light into the mouth of the patient.

### SUMMARY OF THE INVENTION

The present invention provides an intra-oral lighting device for illuminating a tooth located in the mouth of a patient, the device including a source of light, and a probe through which light from the source of light is transmitted, the probe including a tip from which light received from the source of light by the probe is emitted, the tip being insertable by a user (e.g., a dentist or oral surgeon) into an aperture bored into the enamel of the patient's tooth whereby the tooth is illuminated from within by light emitted from the tip.

The present invention also provides a method of illuminating a tooth disposed in the mouth of a patient, including the steps of drilling into the tooth a hole that extends into the tooth enamel, inserting into the drilled hole the tip of a light-transmitting probe connected to a source of light, and emitting light from the probe tip disposed in the drilled hole, whereby the tooth is illuminated from within by light transmitted into and through the tooth enamel from the probe tip.

Accordingly, the present invention addresses the need to illuminate the interior of the mouth, and particularly a tooth or teeth of interest, without having to constantly reposition or redirect light into the mouth of the patient.

### BRIEF DESCRIPTION OF THE DRAWINGS

Advantages of the present invention will be readily appreciated, as the same becomes better understood by reference to the following detailed description when considered in connection with the accompanying drawings wherein:

FIG. 1A is a perspective view of an intra-oral lighting device according to a first embodiment of the invention;

FIG. 1B is a perspective view of an intra-oral lighting device according to a second embodiment of the invention;

FIG. 2 is a fragmentary perspective view a fiber-optic cable and a perspective view of a flexible probe attachment disconnected from the light source of the intra-oral lighting device of FIG. 1A or FIG. 1B;

FIG. 3 is a cross-sectional view of a tooth having a void, showing the tip of a flexible probe attachment inserted into a receiving hole bored into the enamel of the tooth;

FIG. 4 is a cross-sectional view of a capped tooth having a void, showing the tip of a flexible probe attachment inserted into a receiving hole bored through the cap and into the enamel of the tooth;

FIG. 5A is a top view of a tooth having a void, showing the tooth being exteriorly illuminated (i.e., from without) in accordance with the prior art;

FIG. 5B is a top view of the tooth of FIG. 5A, showing the tooth being interiorly illuminated through the tooth enamel (i.e., from within) in accordance with the present invention;

FIG. 6A is a top view of a capped tooth having a void, showing the tooth being exteriorly illuminated (i.e., from without) in accordance with the prior art;

FIG. 6B is a top view of the capped tooth of FIG. 6A, showing the tooth being interiorly illuminated through the tooth enamel (i.e., from within) in accordance with the present invention;

FIGS. 7A-7C show perspective views of various, interchangeable embodiments of substantially rigid probe attachments disconnected from the light source of the intra-oral lighting device of FIG. 1A or FIG. 1B;

FIGS. 8A-8C show alternative uses for using the intra-oral lighting device of the present invention for illuminating various dental procedure sites in the mouth;

FIG. 9 is a cross-sectional view of a tooth having a void, showing the tip of a substantially rigid probe attachment inserted into a receiving hole bored into the enamel of the tooth;

FIG. 10 is a cross-sectional view of a capped tooth having a void, showing the tip of a substantially rigid probe attachment inserted into a receiving hole bored through the cap and into the enamel of the tooth;

FIG. 11 is a cross-sectional view of a tooth with a first substantially rigid probe attachment disposed within a receiving hole bored into the enamel of the tooth, and a second substantially rigid probe attachment disposed within the tooth's nerve canal during a root canal therapy procedure; and

FIG. 12 is a cross-sectional view of a tooth with a first flexible probe attachment disposed within a receiving hole bored into the enamel of the tooth, and a second substantially rigid probe attachment disposed within the tooth's nerve canal during a root canal therapy procedure.

While the invention is susceptible to various modifications and alternative forms, specific embodiments thereof are shown by way of example in the drawings and may herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

Moreover, it is to be noted that the Figures are not drawn to scale and are not drawn to the same scale. In particular, the scale of some of the elements of the Figures is greatly exaggerated to emphasize characteristics of the elements. Elements shown in more than one Figure that may be similarly configured have been indicated using the same reference numerals.

### DETAILED DESCRIPTION OF THE INVENTION

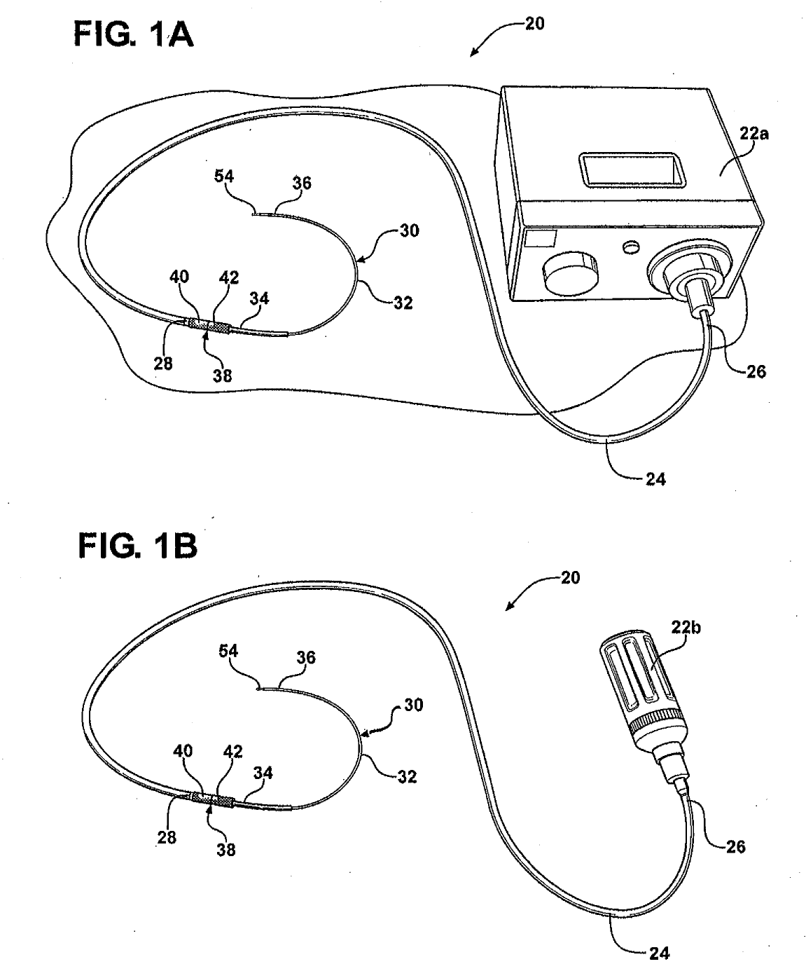

Referring to the Figures, wherein like numerals indicate like or corresponding parts throughout the several views, an intra-oral lighting device 20 is generally shown in FIGS. 1A and 1B. Intra-oral lighting device 20 respectively includes light source 22 (which may be light source 22a or 22b) for emitting a light. Light source 22a is a known table-top model powered through a conventional power cord (not shown) plugged into a 110 volt AC source. Space being at a premium in and around a typical dentist's or oral surgeon's work station, light source 22b is a preferable alternative. Light source 22b is a known, small, portable LED light source powered by a rechargeable lithium ion battery, such as Model PLS (Portable Light Source) available from Optim Incorporated located at 64 Technology Park Road, Sturbridge, Mass. 01566-1253 (www.optimnet.com). It is to be appreciated that the light emitted from light source 22a or 22b may be high intensity light, low intensity light, or any other appropriate lighting type. The Model PLS light source, for example, has a light output of 120 lumens, and a color temperature of approximately 5000K. The portability of light source 22b also permits the user to easily carry between patients located at different work stations. As noted further herein below, light source 22 is detachable from elements of lighting device 20 that are, at least temporarily, patient specific.

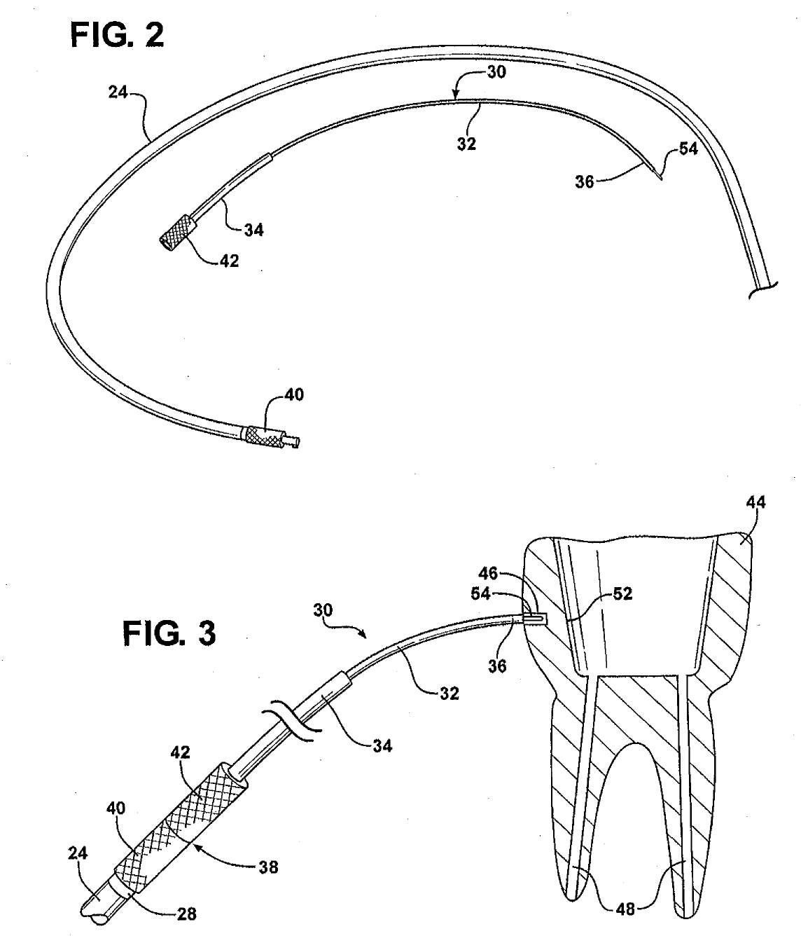

With further reference now to FIG. 2, cable 24, having inlet end 26 and outlet end 28, is coupled, at inlet end 26, to light source 22. Cable 24 is a fiber-optic cable, as known in the art, for transmitting the light from light source 22. However, it is to be appreciated that any appropriate method of light transmission through cable 24 may be used without deviating from the present invention. Cable 24 may be of any convenient length, ranging from as short as several inches, to as long as several feet.

The embodiments of intra-oral lighting device 20 shown in FIGS. 1-4 further include flexible probe attachment 30 disposed on outlet end 28 of cable 24 for focusing the light. Flexible probe attachment 30 includes lead 32 having proximate end 34 and distal end 36. Lead 32 is a fiber-optic cable, as known in the art, for transmitting the light received by probe attachment 30 from cable 24. It is to be appreciated that any appropriate method of light transmission through lead 32 may be used without deviating from the present invention.

Coupling mechanism 38 is disposed between outlet end 28 of cable 24 and proximate end 34 of flexible probe attachment 30 for enabling easy exchange of flexible probe attachment 30. Coupling mechanism 38 includes male member 40 and female member 42. Male member 40 of coupling mechanism 38 is disposed on outlet end 28 of cable 24, and female member 42 of coupling mechanism 38 is disposed on proximate end 34 of lead 32 for mating female member 42 with male member 40 of coupling mechanism 38.

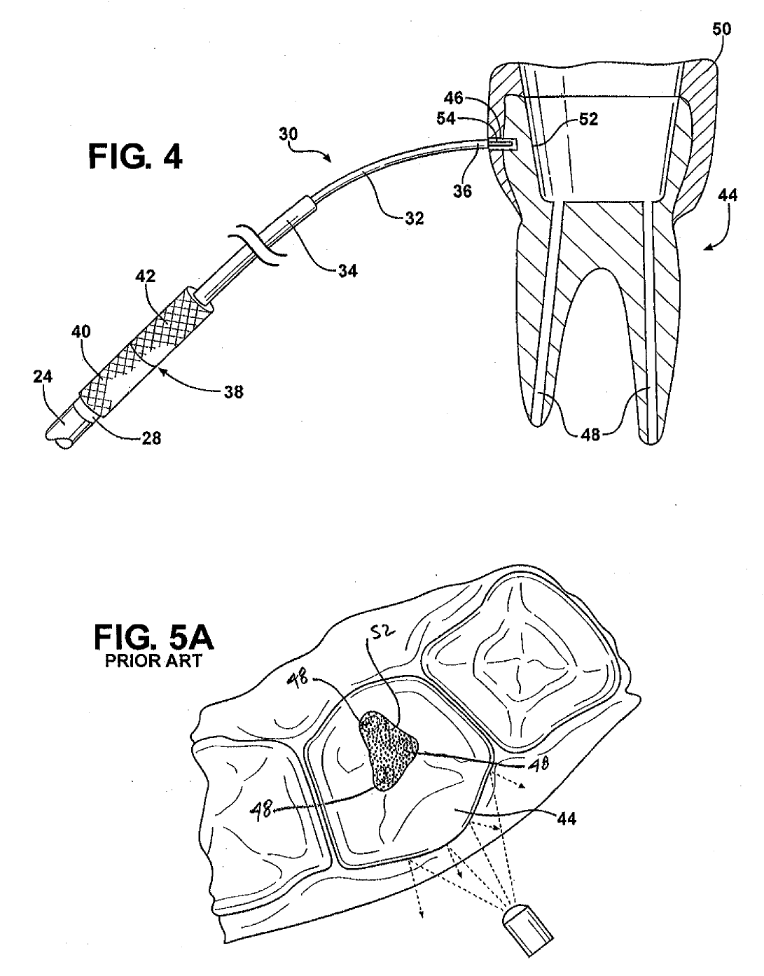

A user utilizes intra-oral lighting device 20 on a patient. The patient has a mouth having at least one tooth 44 disposed within the mouth. Referring to FIGS. 3 and 4, tooth 44 defines aperture 46. Generally, aperture 46 is a bored hole created by the user drilling into the enamel of tooth 44. Tooth 44 further defines nerve canals 48. It is to be appreciated that tooth 44 can include substantially opaque cap 50 disposed on the outside surface of the enamel of tooth 44, as shown in FIG. 4. Tooth 44 and its cap 50 (if any) can define void 52 created in the tooth and within which may be the site of the dental procedure to be illuminated in accordance with the present invention. Notably, bored hole 46 may, but need not, extend into void 52. It is sufficient that bored hole 46 extend only into the translucent enamel of tooth 44.

Flexible probe attachment 30 has tip 54 located at its distal end or free end. Tip 54 may be is hollow or has a core of light transmissible material for allowing the light that is transmitted through lead 32 to be emitted. Probe 30 may range in overall length from a few inches to a few feet. The cylindrical outer wall of tip 54 may include a jacket, coating or other covering that is substantially opaque, thereby permitting light to be emitted only from the axial end of tip 54. Tip 54 of lead 32 is inserted into aperture 46 defined by tooth 44 for illuminating tooth 44 from within, i.e., through the tooth enamel. Such illumination of tooth 44 enables the user to more easily see inside void 52 and locate nerve canals 48 defined by tooth 44, or to see portions of tooth 44 within void 52 that are blocked by cap 50 on tooth 44. Once the dental procedure on tooth 44 is completed, void 52 and aperture 46 is filled or tooth 44 is crowned by the user, as appropriate.

Flexible probe 30 may be provided in a sterilized state to the user, perhaps in an individually sealed package. Probe 30 may be disposable, and once used on a patient and disconnected from cable 24, disposed of. Alternatively, probe attachment 30 may be reusable, and resterilized after use on a particular patient, then reused on a different patient after resterilization.

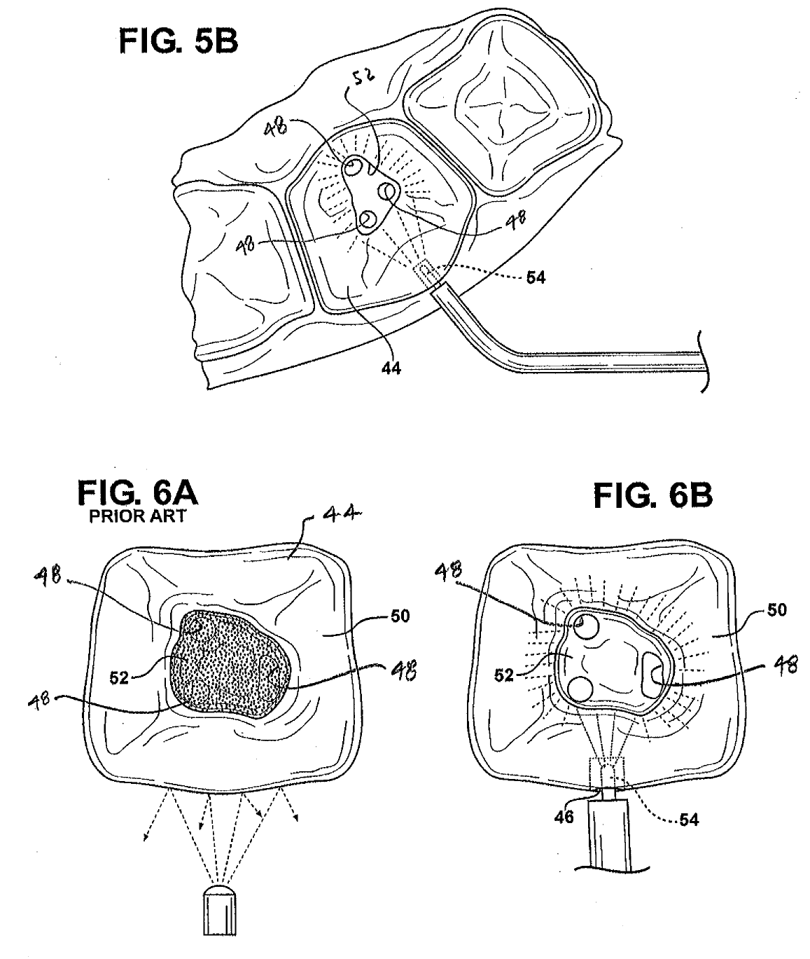

Referring to FIG. 5A, it can be seen that exteriorly lighting tooth 44 (i.e., illuminating it from without) leaves void 52 substantially in shadow, thereby preventing a clear view into void 52 and of nerve canals 48. Much of the light incident upon the exterior surface of tooth 44 is reflected off of that surface, rather than proceeding through the tooth enamel to illuminate tooth 44 from within. It has been found that even abutting the light-emitting tip 54 at the free end of probe attachment 30 directly against the exterior enamel surface of tooth 44 does not illuminate tooth 44 to a degree approximating that achieved when using device 20 in accordance with the method of the present invention.

Referring to FIG. 5B, tooth 44 is illuminated from within, or through its enamel, by tip 54 being received into bored hole 46, which extends into the tooth enamel. The tooth enamel, being translucent, transmits light directed into aperture 46 both axially, relative to the orientation of tip 54, and refractively in other directions through tooth 44, causing its enamel to be illuminated. The enamel tooth walls defining void 52 and nerve canals 48 are thus illuminated from inside or from within tooth 44, thereby facilitating the user's easier viewing of the site of the dental procedure without relying (at least solely) on direct external lighting of the site from the exterior of or outside the tooth (i.e., illumination from without the tooth).

Aperture 46 is drilled at a diameter that substantially matches the diameter of tip 54 to be inserted thereinto. Thus, light emitted from tip 54 is generally focused directly into the tooth enamel and not reflected by the tooth enamel within hole 46 and reversely directed out of the opening of aperture 46, past inserted probe tip 54, to an appreciably detrimental extent. The diameter of tip 54 may range from about 0.020 inch to about 0.059 inch.

Referring to FIG. 6A, tooth 44 is covered by substantially opaque cap 50, which may be porcelain coating a gold or silver backing. Light focused on the exterior of capped tooth 44, even when abutting the surface of cap 50, does not penetrate the cap, and so void 52 remains substantially in shadow, obscuring the view of the dental procedure site within void 52 and/or nerve canals 48. Referring now to FIG. 6B, in accordance with the present invention, aperture 46 is drilled through cap 50 and into the underlying enamel of tooth 44, and tip 54 of intra-oral lighting device 20 is inserted into the bored hole to illuminate tooth 44 from within as described above, thereby facilitating easier viewing of the site requiring dental procedure without relying (at least solely) on direct external lighting of the site from the exterior of or outside the tooth (i.e., illumination from without the tooth).

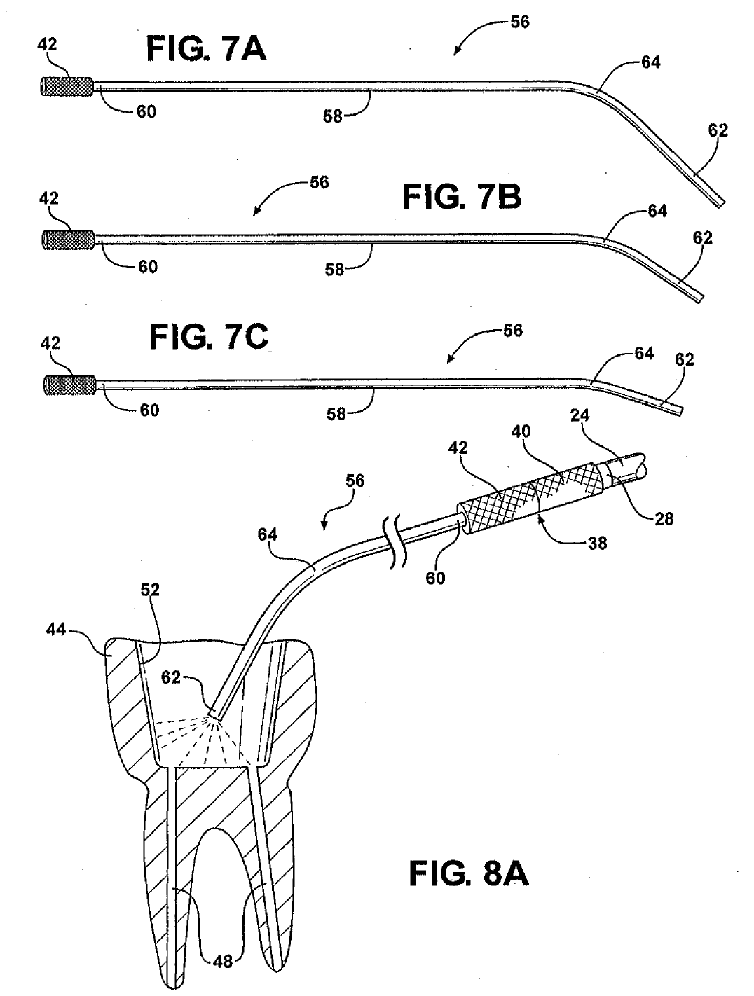

Embodiments of interchangeable, substantially rigid probe attachments 56 that may be coupled to cable 24 are shown if FIGS. 7-10. In these embodiments of intra-oral lighting device 20, substantially rigid probe attachment 56 is used in place of flexible probe attachment 30. As used herein, “rigid” or “substantially rigid” shall be understood to refer to the probe's ability to substantially maintain its preformed shape and resist bending, or to be plastically deformed by the user into a desired shape or configuration that is substantially maintained until reconfigured by the user into a different shape or configuration.

Rigid probe attachment 56 comprises cylindrical shaft 58 having first end 60 and second end 62. Female member 42 of coupling mechanism 38 is disposed on first end 60 of probe 56 for mating with male member 40 of coupling mechanism 38. Rigid probe attachment 56 further includes elbow 64 disposed near second end 62 for allowing the user to direct the light into areas of the mouth that cannot be accessed with flexible probe attachment 30. It is to be appreciated that elbow 64 can be located at various positions along cylindrical shaft 58, and bent at various angles, as seen in FIGS. 7A-7C. This embodiment of the invention utilizes fiber-optics, as known in the art, to direct the light received from light source 22 via cable 24 through rigid probe attachment 56. It is also to be appreciated that any appropriate method of light transmission through rigid attachment 56 may be used without deviating from the present invention.

Cylindrical shaft 58 and its female coupling member 42 may be made from surgical stainless steel, and have a core of light transmissive fiber-optic material therethrough. Cylindrical steel shaft 58 provides probe 56 with a substantially opaque jacket that permits light to be emitted axially from the probe tip at second end or free end 62. Probe 56 may be disconnected from cable 24 and sterilized, for example in an autoclave, repeatedly, and reused on a different patient after being resterilized. The cylindrical tip of second end 62, from which light is emitted, may have a diameter ranging from 0.020 inch to 0.059 inch, and that substantially matches the diameter of bored hole 46 into which it is received. For example, interchangeable probes 56 may have respective diameters of 0.020, 0.028, 0.046 and 0.059 inch, with the smaller diameter tip sizes had by probes 56 of a type intended to be plastically deformed by the user to the desired shape, as described above, whereas the probes 56 having the larger diameter tip sizes exhibit relatively greater rigidity.

Angles defined by elbows 64 of interchangeable probes 56 may variously range from obtuse angles to acute angles, with angles of 45° and 90° being generally preferred. The shaft length between the tip of second end 62 and elbow 64 may be any convenient length, with a length of about one inch being generally preferred. Overall length of cylindrical shaft 58 between first and second ends 60, 62 may be any convenient length, and may range from a few inches to about three feet. Generally, the length should be sufficient for first end 60 to be well outside of the patient's mouth or likely range of contamination therefrom during the dental procedure. Probes 56 as herein described have been obtained from Fiberoptics Technology, Inc. located at 1 Quassett Road, Pomfret, Conn. 06258 (www.fiberoptix.com).

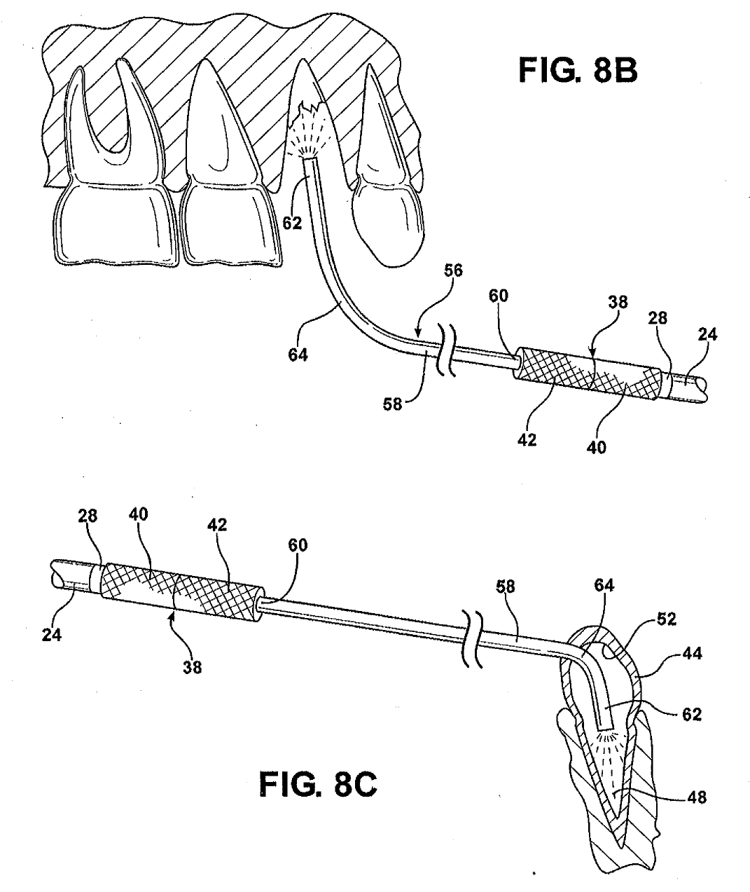

FIGS. 8A-8C show various uses of intra-oral lighting device 20 having substantially rigid probes 56 for externally illuminating various dental procedure sites. Probes 56 permit light to be directed where needed inside a patient's mouth with greater reach, control and precision than previously possible, even when not used to illuminate a tooth from within, as described above, and provide another advantage over the prior art afforded by a device according to the present invention.

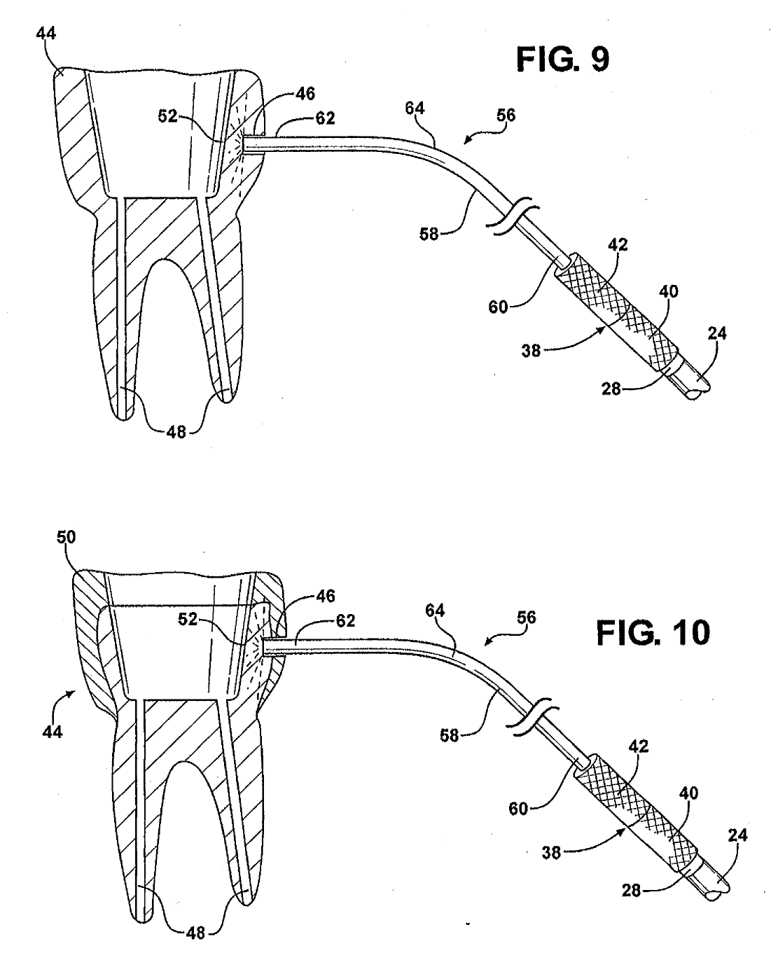

Referring to FIGS. 9 and 10, as discussed above, tooth 44 defines aperture 46 that is a bored hole created by the user drilling into the tooth enamel, and nerve canals 48. Tooth 44 may include substantially opaque cap 50 (FIG. 10). Void 52 created in tooth 44 and its cap 50 (if any) may be the site of the dental procedure to be illuminated in accordance with the present invention. As noted above, bored hole 46 extends into the enamel of tooth 44, and may, but need not, extend into void 52. The tip of second end or free end 62 of substantially rigid probe attachment 56 is inserted into aperture 46 for illuminating tooth 44 from within, i.e., through the tooth enamel, thus illuminating tooth 44 to enable the user to more easily see inside void 52 and locate the nerve canals 48, or for illuminating portions of tooth 44 within void 52 that are blocked by cap 50 on tooth 44. Once the dental procedure on tooth 44 is completed, void 52 and aperture 46 is filled or tooth 44 is crowned by the user, as appropriate.

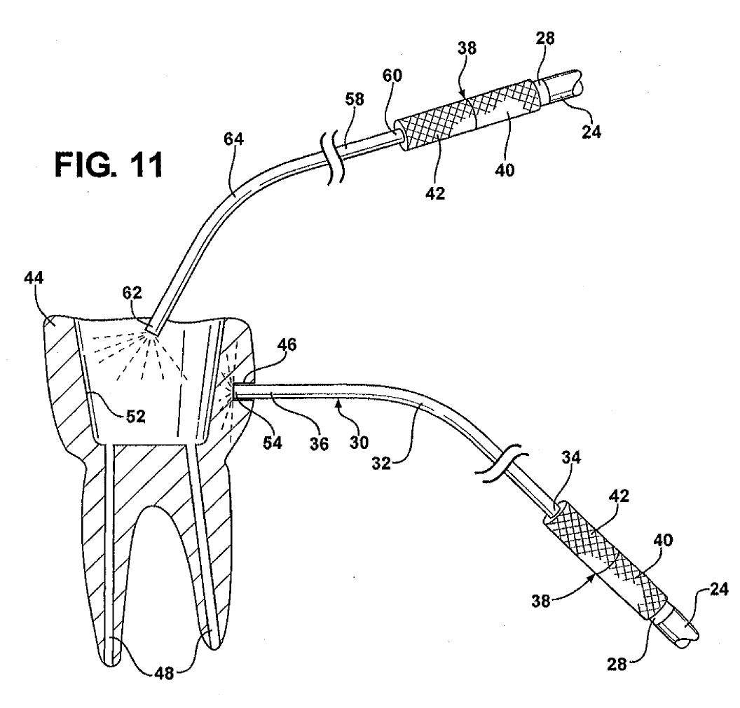

One of ordinary skill in the art can appreciate that device 20 may include a primary probe 30 or 56, for illuminating tooth 44 from within, and a secondary lighting attachment or probe 30 or 56, the primary and secondary probes combined into a single attachment coupled to the light source 22 without deviating from the present invention. Additionally, it is to be appreciated that intra-oral lighting device 20 can accommodate a plurality of flexible attachments and/or a plurality or rigid attachments without deviating from the present invention. It is to be further appreciated that the plurality of flexible attachments 30 and/or the plurality of rigid attachments 56 can be disposed on a single female member 42 of the coupling mechanism 38 for mating with male member 40 of coupling mechanism 38. It is also to be appreciated that a plurality of cables 24 may be connected to one or more light sources 22 for accommodating the plurality of flexible probe attachments 30 and/or rigid probe attachments 56, as shown in FIG. 11.

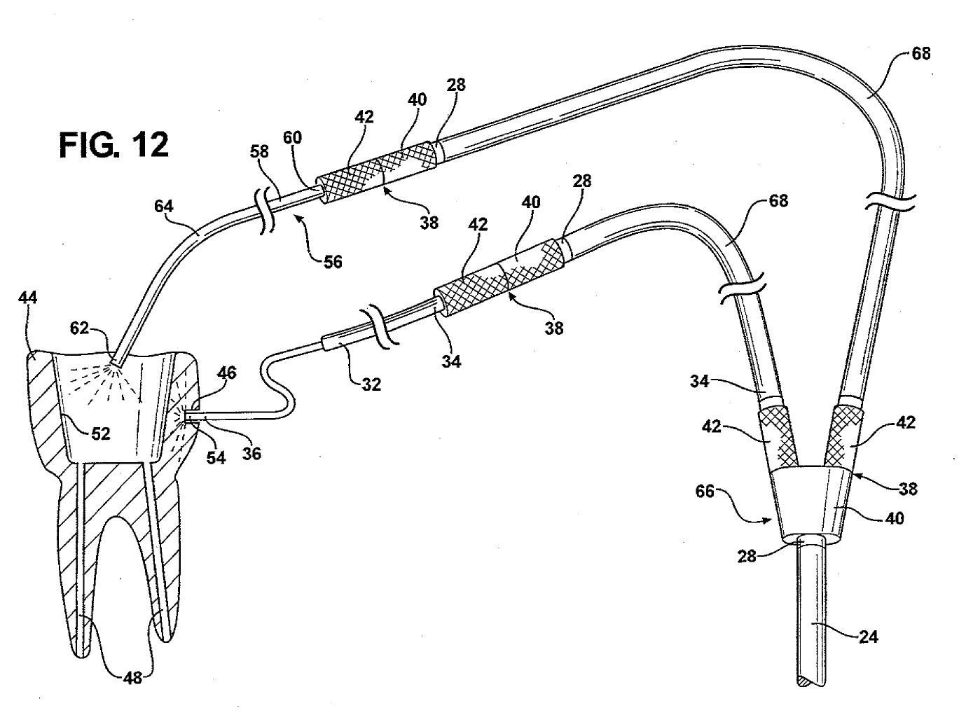

It is to be further appreciated that splitter 66 may be disposed on outlet end 28 of cable 24 for splitting the light received by the splitter into a plurality of secondary fiber-optic cables 68, the structure of each secondary cable being substantially similar to cable 24. Each of the plurality of secondary cables 68 has male member 40 of coupling mechanism 38 disposed on its outlet end 28, which is mated with a female member 42 disposed on proximate end 34 of a flexible probe attachment 30 and/or first end 60 of a substantially rigid probe attachment 56, as shown in FIG. 12.

The invention has been described in an illustrative manner, and it is to be understood that the terminology which has been used is intended to be in the nature of words of description rather than of limitation. It is now apparent to those skilled in the art that many modifications and variations of the present invention are possible in light of the above teachings. It is, therefore, to be understood that the invention may be practiced otherwise than specifically described.

What is claimed is:

1. An intra-oral lighting device for illuminating a tooth located in the mouth of a patient, said device comprising:
a source of light;
a probe through which light from said source of light is transmitted, said probe including a tip from which light received from said source of light by said probe is emitted;
said tip being insertable by a user into an aperture bored into the enamel of the patient's tooth whereby the tooth is illuminated from within by light emitted from said tip.

2. The intra-oral lighting device of claim 1, wherein said probe is detachably coupled to said source of light.

3. The intra-oral lighting device of claim 2, further comprising a fiber-optic cable operably connected to said source of light and said probe, light transmitted from said source of light to said probe being transmitted through said fiber-optic cable.

4. The intra-oral lighting device of claim 3, wherein said probe is detachably coupled to said fiber-optic cable.

5. The intra-oral lighting device of claim 2, wherein said probe is substantially sterile prior to being coupled to said source of light.

6. The intra-oral lighting device of claim 5, wherein said probe is disposable, and after being placed into the patient's mouth is not placed into a different patient's mouth.

7. The intra-oral lighting device of claim 5, wherein said probe is reusable, and after being placed into the patient's mouth is resterilized prior to being placed into a different patient's mouth.

8. The intra-oral lighting device of claim 1, wherein said probe is a fiber-optic member having a light-transmissive core having an axial end and being surrounded by a substantially opaque covering, said core axial end comprising said tip.

9. The intra-oral lighting device of claim 8, wherein said covering is stainless steel.

10. The intra-oral lighting device of claim 1, wherein said probe is substantially flexible.

11. The intra-oral lighting device of claim 1, wherein said probe is substantially rigid.

12. The intra-oral lighting device of claim 11, wherein said probe is plastically deformable by a user into various different configurations.

13. The intra-oral lighting device of claim 1, wherein said tip is substantially cylindrical and has a diameter substantially matching the diameter of the bored aperture into which said tip is insertable.

14. The intra-oral lighting device of claim 1, further comprising:
a light splitter disposed between said probe and said source of light, light received from said source of light by said probe being transmitted through said splitter; and
a secondary lighting attachment through which light from said source of light is transmitted, said secondary lighting attachment including a tip from which light received from said source of light by said secondary lighting attachment is emitted, light received from said source of light by said secondary lighting attachment being transmitted through said splitter;
wherein light emitted from said secondary lighting attachment tip is directed onto the exterior of the tooth, whereby the tooth is illuminated from within by light emitted by said probe tip, and from without by light emitted by said secondary lighting attachment tip.

15. The intra-oral lighting device of claim 14, wherein said probe and said secondary lighting attachment are detachably coupled to said splitter.

16. A method of illuminating a tooth disposed in the mouth of a patient, comprising the steps of:
drilling into the tooth a hole that extends into the tooth enamel;
inserting into the drilled hole the tip of a light-transmitting probe connected to a source of light;
emitting light from the probe tip disposed in the drilled hole, whereby the tooth is illuminated from within by light transmitted into and through the tooth enamel from the probe tip.

17. The method of claim 16, wherein said step of drilling into the tooth includes drilling through a cap covering the tooth enamel.

18. The method of claim 16, wherein the tooth has a void defined by tooth enamel, and further comprising the step of visually inspecting the interior of the void with the assistance of the tooth being illuminated from within.

19. The method of claim 18, wherein the light-transmitting probe is a first light-transmitting probe, and further comprising the steps of:
emitting light from the tip of a second light-transmitting probe connected to a source of light; and
directing the light emitted from the tip of the second light-transmitting probe into the void, whereby illumination provided by light transmitted from the first light-transmitting probe into and through the tooth enamel is supplemented by light emitted from the second light-transmitting probe onto the void-defining tooth enamel.

20. The method of claim 16, wherein the tooth has a void defined by tooth enamel, including the step of performing a dental procedure within the void under illumination being provided by light emitted by the probe tip into the drilled hole.
